(19) United States
(12) Patent Application Publication
(10) Pub. No.: US 2026/0282121 A1
(43) Pub. Date: Sep. 17, 2026

(54) FACILITATING USER EQUIPMENT (UE) PROVISIONING OVER A CELLULAR NETWORK

(71) Applicant: Boost SubscriberCo L.L.C., Englewood, CO (US)

(72) Inventor: Xiaowen S. Robinson, Great Falls, VA (US)

(21) Appl. No.: 19/077,925

(22) Filed: Mar. 12, 2025

(51) Int. Cl. H04W 76/10; H04L 61/30; H04L 101/375; H04W 60/04

(52) U.S. Cl. CPC H04W 76/10; H04L 61/30; H04W 60/04; H04L 2101/375

(57) ABSTRACT

Technology embodied in a method that includes receiving, at a network device from the UE over a protocol data unit (PDU) session or a packet data network (PDN) session established between the UE and the cellular network, one or more data packets, and determining that the one or more data packets pertain to at least one resource included in a preconfigured list of resources the UE is allowed to access over the cellular network without being provisioned to the cellular network. In response, the UE is allowed to access the at least one resource. The method further includes receiving, from the UE over the PDU session, first information pertaining to provisioning at least one of the UE or a subscriber identification module (SIM) associated with the UE, and providing second information configured to provision a subscriber-account associated with the UE or the SIM, to access the cellular network.

### TECHNICAL FIELD

This specification relates to provisioning a UE and a corresponding subscriber identification module (SIM) over a wireless network such as a 5G Wireless Open Radio Access Network (O-RAN).

### BACKGROUND

A new subscriber to a wireless service typically requires a Wi-Fi network to access the Internet in order to provision a UE and the new SIM to the cellular network associated with the wireless service.

### SUMMARY

In one aspect, this document features a method of provisioning a user equipment (UE) over a cellular network, the method including receiving, at a network device from the UE over a protocol data unit (PDU) session or a packet data network (PDN) session established between the UE and the cellular network, one or more data packets, and determining that the one or more data packets pertain to at least one resource included in a preconfigured list of resources the UE is allowed to access over the cellular network without being provisioned to the cellular network. The method also includes, responsive to determining that the at least one resource is included in the preconfigured list of resources, allowing the UE to access the at least one resource. The method further includes receiving, from the UE over the PDU session, first information pertaining to provisioning at least one of the UE or a subscriber identification module (SIM) associated with the UE, and providing second information configured to provision a subscriber-account associated with the UE or the SIM, to access the cellular network.

In another aspect, this document features a device that includes memory configured to store computer-readable instructions, and one or more computing devices operatively coupled to the memory and configured to execute the computer-readable instructions to perform various operations. The operations include receiving, at a network device from the UE over a protocol data unit (PDU) session or a packet data network (PDN) session established between the UE and the cellular network, one or more data packets, and determining that the one or more data packets pertain to at least one resource included in a preconfigured list of resources the UE is allowed to access over the cellular network without being provisioned to the cellular network. The operations also include, responsive to determining that the at least one resource is included in the preconfigured list of resources, allowing the UE to access the at least one resource. The operations further include receiving, from the UE over the PDU session, first information pertaining to provisioning at least one of the UE or a subscriber identification module (SIM) associated with the UE, and providing second information configured to provision a subscriber-account associated with the UE or the SIM, to access the cellular network.

In another aspect, this document features one or more non-transitory computer-readable storage devices configured to store computer-readable instructions, which, upon execution by one or more computing devices cause the one or more computing devices to perform various operations. The operations include receiving, at a network device from the UE over a protocol data unit (PDU) session or a packet data network (PDN) session established between the UE and the cellular network, one or more data packets, and determining that the one or more data packets pertain to at least one resource included in a preconfigured list of resources the UE is allowed to access over the cellular network without being provisioned to the cellular network. The operations also include, responsive to determining that the at least one resource is included in the preconfigured list of resources, allowing the UE to access the at least one resource. The operations further include receiving, from the UE over the PDU session, first information pertaining to provisioning at least one of the UE or a subscriber identification module (SIM) associated with the UE, and providing second information configured to provision a subscriber-account associated with the UE or the SIM, to access the cellular network.

The above aspects can include one or more of the following features. The network device can be configured to implement a module of a 5G core. The module of the 5G core can be one of: an access management function (AMF) module or a user plane function (UPF) module. The method or operations can include receiving and storing the preconfigured list of resources at the network device. The resources in the preconfigured list can include a SIM over-the-air (OTA) application. The resources in the preconfigured list can include one or more application repositories configured to store applications downloadable on the UE to provision the UE to access the cellular network, and the applications downloadable on the UE to provision the UE to access the cellular network. The PDU session or PDN session can be established for data service over the cellular network without the UE being provisioned to access the cellular network. The method or the operations can include determining that the one or more data packets include an identification of a first data network that is not included in the preconfigured list of resources, and in response, routing the one or more data packets over a second data network that is included in the preconfigured list of resources. The preconfigured list of resources can include at least one of an access point name (APN) or a data network name (DNN) associated with the cellular network.

Various implementations of the technology described herein may provide one or more of the following advantages.

By allowing for a new SIM to access certain data services of a cellular network, the technology described herein can be used to support provisioning of the SIM and the associated UE over the cellular network, and without connecting to a Wi-Fi or other non-cellular networks to access the Internet. Specifically, an unprovisioned user equipment (UE) and/or the corresponding SIM can be configured to access a limited number of resources (e.g., service landing page associated with the cellular network, the SIM over-the-air (OTA) server, and/or third-party application repositories) to access requisite resources to complete a self-onboarding process. This can allow new customers to gain full access to the cellular network faster than they would have been able to otherwise while avoiding potential security issues associated with an unprovisioned UE having full access to the cellular network.

Other features and advantages of the description will become apparent from the following description, and from the claims. Unless otherwise defined, the technical and scientific terms used herein have the same meaning as commonly understood by one of ordinary skill in the art to which this invention belongs.

### BRIEF DESCRIPTION OF THE DRAWINGS

FIG. 1 is a diagram of an example of a network environment and a user equipment (UE) device connected to the network environment.

FIG. 2 is a schematic diagram illustrating an unprovisioned UE communicating with a provider portal, a SIM OTA server, and third-party application repository over a cellular network, in accordance with technology described herein.

FIG. 3 is a schematic diagram illustrating a sequence of interactions to activate a new UE over a cellular network.

FIG. 4 is a flowchart of a process executed at a UE to get provisioned over a cellular network.

FIG. 5 is a flowchart of a process executed at a network device to provision a UE over a cellular network.

FIG. 6 is a diagram illustrating an example of a computing environment usable to implement technology described herein.

### DETAILED DESCRIPTION

The present technology enables the provisioning or activation of a new User Equipment (UE) and/or Subscriber Identity Module (SIM) over a cellular network. Typically, new subscribers seeking to activate a UE and/or SIM on a cellular network require Internet access via a Wi-Fi network to perform tasks such as SIM/eSIM and device configuration, account setup, Mobile Station International Subscriber Directory Number (MSISDN) assignment, or porting. This dependency on Wi-Fi can pose challenges for users without immediate Wi-Fi access, leading to activation delays. Conversely, UEs and SIMs cannot be granted full access to a cellular network's data services until they are provisioned or registered with the network's service provider. The described technology introduces a “walled garden” approach, where new SIMs are pre-provisioned to access limited data services of the cellular network specifically for provisioning or registration purposes. For example, The SIM/eSIM can be preconfigured with user identifier (e.g., international mobile subscriber identity—IMSI), user-credential, etc. and pre-provisioned in the cellular network with the same information together with a data network name (DNN) and/or access point name (APN) such that a new UE can register to the cellular network and establish a data session over the cellular network for account-setup, full provisioning, etc.

In some implementations, this technology allows a UE to access a restricted set of resources over the cellular network's data services, even if the UE is not yet provisioned. These limited resources facilitate the provisioning or registration of the UE/SIM with the cellular network. Examples of such resources include a service landing page associated with the cellular network, a SIM over-the-air (OTA) server, and third-party application repositories containing applications necessary for the self-onboarding process. By providing controlled access to these limited resources, the technology supports the provisioning of UEs/SIMs without the need for a Wi-Fi network, while addressing security and logistical concerns associated with allowing unprovisioned UEs to access the cellular network.

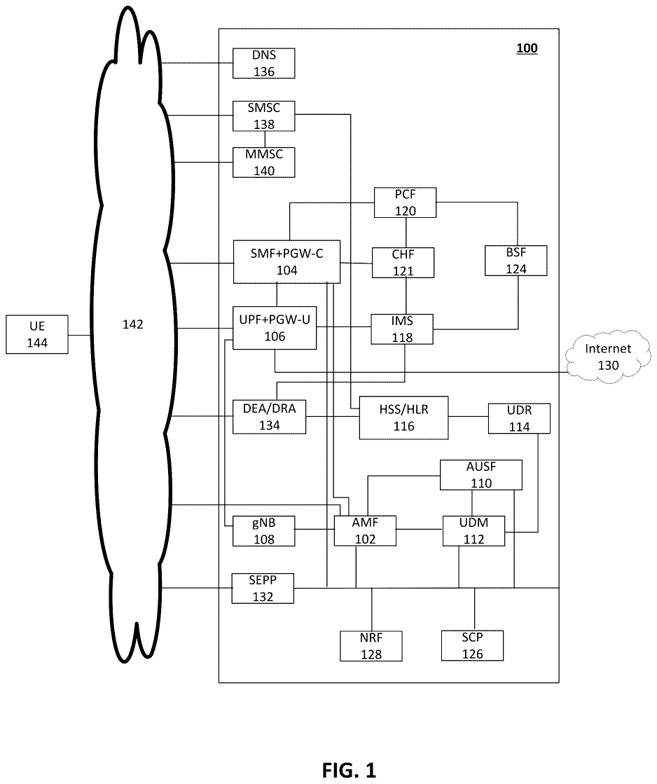

FIG. 1 depicts a diagram of an exemplary network environment 100 and a user equipment (UE) device 144 connected to the exemplary network environment. As used herein, a network environment (sometimes referred to herein simply as an environment) refers to a set of multiple devices, modules, and functions that are configured to jointly enable wireless communication. For example, a network environment can include a 5G network that includes a set of multiple devices, radio access network (RAN)/core network functions, and application functions that are configured and integrated to jointly enable wireless communication. An environment, such as the environment 100, can be a portion of a 5G New Radio (“5G-NR” or simply “5G”) cellular network environment. Standards for cellular network architectures have previously been described, for example, in 3GPP TS 23.501 (for 5G networks) and 3GPP TS 23.401 (for 4G long-term evolution “LTE” networks) (the entireties of which are hereby incorporated by reference). While FIG. 1 shows an exemplary architecture for a network environment (i.e., environment 100), it is not intended to be limiting. The lines depicted in FIG. 1 that connect network elements are indicative of the possibility of direct communication between those network elements.

Network environment 100 includes a packet core network, which includes an access management function (AMF) 102, a session management function and packet data network gateway-control module (SMF+PGW-C) 104, a user plane function and packet data network gateway-user plane module (UPF+PGW-U) 106, and a policy control function (PCF) 120. The AMF 102 receives all connection and session related information from one or more user equipment (UE) devices 144, and handles connection and mobility management tasks. The AMF 102 forwards all messages related to session management to the SMF+PGW-C module 104. The SMF+PGW-C module 104 and UPF+PGW-U module 106 jointly manage sessions and are configured using Control and User Plane Separation (CUPS). The PCF 120 communicates with the SMF+PGW-C module 104, governing control plane functions via defined policy rules. The UPF+PGW-U module 106 can provide access to the Internet 130 for data applications and the IP Multimedia Subsystem (IMS) core module 118 for voice applications. The IMS core module 118 is a separate application core network from the packet core network and supports voice services, messaging, video calls, etc.

The environment 100 can further include a charging function (CHF) 121 and a binding support function (BSF) 124. The CHF 121 supports online and offline charging features and completes billing functions. The BSF 124 tracks sessions that are located anywhere in the environment 100, but share common criteria, such as subscriber identifiers. The BSF 124 communicates with the PCF 120 and binds application-function requests to specific PCF instances, enabling policy scaling of the environment 100.

The environment 100 also includes a gNB 108 (i.e., a 5G base station), which handles run-side aspects of the network environment 100 and communicates, either directly or indirectly, with the packet core network elements such as AMF 102, SMF+PGW-C module 104, and UPF+PGW-U module 106.

The environment 100 further includes network elements to manage user or subscriber information. For example, the environment 100 includes an authentication service function (AUSF) 110 for user authentication and a unified data management (UDM) module 112. The user database is stored in a unified data repository (UDR) 114. The UDM 112 communicates with the AMF 102, AUSF 110, and the UDR 114 to provide centralized control of network user data. For interworking with 2G, 3G, and 4G network elements, the environment 100 also includes a Home Subscriber System and Home Location Register (HSS/HLR) module 116, which stores subscriber information, location and SIM details, and authentication keys.

The environment 100 further includes a service communication proxy (SCP) 126 and a network repository function (NRF) 128. In accordance with current 5G standards, network functions are based on HTTP version 2, and use the SCP 126 and NRF 128 to communicate. The NRF 128 is used to discover network functions in the environment 100, and the SCP 126 is used to provide a single point of entry for a cluster of discovered network functions, serving as a central control point in the signaling network core.

The environment 100 further includes a security edge protection proxy (SEPP) 132, a diameter edge agent and diameter routing agent (DEA/DRA) module 134, and a domain name system (DNS) 136. The SEPP 132 is a security proxy through which all signaling traffic across operator networks is expected to transit. The DEA/DRA module 134 manages traffic and congestion of messages routed across the environment 100, routing signaling traffic and performing load balancing, relay, proxy and redirect functions within a carrier or interworking with other carriers. The DNS 136 is a naming database in which internet domain names are located and translated into internet protocol (IP) addresses.

The environment 100 further includes a short message service center (SMSC) 138 and a multimedia message service center (MMSC) 140 configured to receive, store, route, and forward SMS messages and MMS messages, respectively.

The network environment 100 is configured to interact with external systems 142. In some implementations, the external systems 142 can include another network such as a 4G or 5G roaming partner network. For example, the environment 100 can interact with a roaming partner network using an IP Packet eXchange (IPX) telecommunications interconnection model provided between the two network environments. In other examples, the environment 100 can interact directly with the roaming partner network environment without an IPX provider in between the two networks.

In some implementations, the external systems 142 can include a message aggregator configured to aggregate messages and route a portion of the aggregated messages to the environment 100. For example, the aggregated messages can be SMS or MMS messages.

The UE 144 can interact with the network environment 100 indirectly through the external systems 142 or directly with the network environment 100 (e.g., via the gNB 108). In some cases, the UE 144 can be a subscriber to the network environment 100 (e.g., a subscriber to a service provider of the cellular network). In other cases, the UE 144 can be a non-subscriber roaming on the network environment 100.

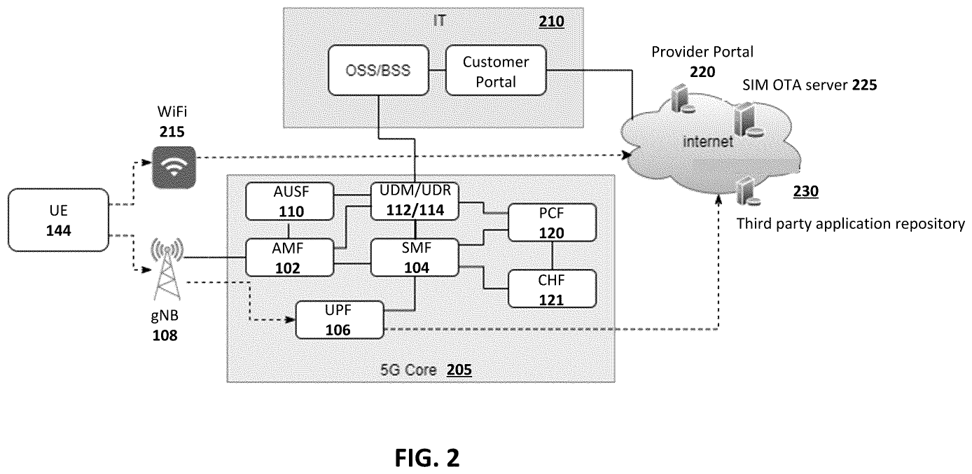

FIG. 2 shows how a portion of the network environment 100 can be used to implement technology described herein. Specifically, FIG. 2 is a schematic diagram illustrating an unprovisioned UE 144 communicating over a portion of the network environment 100 (the 5G core 205, in this example) with a provider portal 220, a SIM OTA server 225, and third-party application repository 230. The provider portal 220 can include a landing page that allows a new user to create an account with the service provider associated with the cellular network. The SIM OTA server 225 can include one or more computing devices that allow network operators to remotely manage SIM cards and services. The third-party application repository 230 can be accessed through a corresponding application (e.g., an “app store”) to download one or more device or carrier applications configured to assist with device provisioning or set-up. For example, an application (also referred to as an “app”) of the cellular network service provider may be downloaded and installed on an UE as part of the provisioning process. Furthermore, some of the third-party applications, such as device manager or carrier bundle manager, can be accessed during the provisioning process for proper carrier service bundle and device configurations.

In some implementations, the SIM OTA server 225 can include a back-end system that can be configured to interact with an OTA gateway or platform to provide configuration or provisioning information to a SIM on an UE. In some implementations, the back-end system sends service requests to the OTA gateway, which converts these requests into a suitable format (e.g., a short message) for transmission to one or more SIM cards in the field. The OTA gateway can be configured to receives service requests from the back-end system through an application programming interface (API), indicating the specific card to modify/update/activate. The OTA gateway can be configured to format the service request into a format that the recipient's SIM card can understand, for example, using libraries specifying the formats for various SIMs.

If a UE has access to a Wi-Fi network 215, accessing the provider portal 220, the SIM OTA server 225, or third-party application repository 230 over the Internet can be facilitated by the Wi-Fi network. However, often times, an unprovisioned UE 144 may be at a location where the UE has no access to a usable Wi-Fi network. In such cases, the technology described herein allows the UE 144 to access a limited number of resources (e.g., the provider portal 220, the SIM OTA server 225, and/or the third-party application repository 230) over a portion of the cellular network (the 5G core 205, in this example that features a 5G O-RAN). In some implementations, this can be facilitated by allowing for establishment of a protocol data unit (PDU) session between the UE 144 and the 5G core 205 for data service, even without subscription or subscriber provisioning for the UE 144. For example, the SIM/eSIM in the UE can be preconfigured to access a particular virtual network with a corresponding data network name (DNN) and/or Access Point Name (APN) within the cellular network. When the SIM/eSIM accesses data service over that particular APN/DNN, the cellular network allows the SIM/eSIM/UE to access a limited number of predetermined resources for provisioning purposes.

In some implementations, a list of the partially pre-provisioned SIMs is maintained at a network module (e.g., the UDR 114) of the 5G Core 205 as a part of unified data management (UDM) 112. In some implementations, the “internet” DNN is set to the default APN/DNN in UDM subscription. In some implementations, if the UE underlying the partially pre-provisioned SIM requests data service using another APN/DNN that does not match a provisioned APN/DNN, the network module (e.g., the AMF 102) can be configured to override the request and use the provisioned APN/DNN instead. Any “internet” PDU session set up through the provisioned APN/DNN can be configured to prevent any other type of traffic except to and from resources that are included in a “whitelist”—e.g., a list of sites and application addresses that are used in the onboarding/provisioning process for the UE/SIM. In some implementations, configuration information for the UE/SIM can be transmitted from the 5G Core 205 to the UE 144 over the PDU session to complete the onboarding process. Upon the completion of the onboarding, the SIM/eSIM and UE are fully configured for full access to the cellular network, and the UE has full access to the subscribed services.

In some implementations, the provisioning functionalities can be supported by an information technology module/device 210. The IT module/device can be a part of a domain responsible for implementing and managing the technology infrastructure that supports operations and processes described herein. For example, the IT module 210 can be configured to support operations support systems (OSS) and/or business support systems (BSS) associated with a telecommunication company implementing the technology described herein. The IT module can also support a customer portal for the company. The OSS/BSS and customer portal can be configured to provide various services, e.g. subscriber or customer onboarding, provisioning, billing, etc. In some implementations, the IT module 210 can be an API Gateway.

In some implementations, the IT module 210 can be configured to provision a subscriber-account to the UDR 114 via a Provisioning Gateway or API Gateway such that the UDM 112, SMF 104, and/or PCF 120 can retrieve the information from the UDR. The information provided by the IT module 210 to the UDR 114 can include, for example, subscriber id, authentication credential, DNN, service profile, rate plan, etc. In some implementations, the provisioning process supported by the IT module 210 also includes checking the subscriber service area, assigning a telephone number, executing a number portability process, informing SIM OTA to provision the SIM profile, informing a device manager to configure the device with the carrier's service bundle, etc.

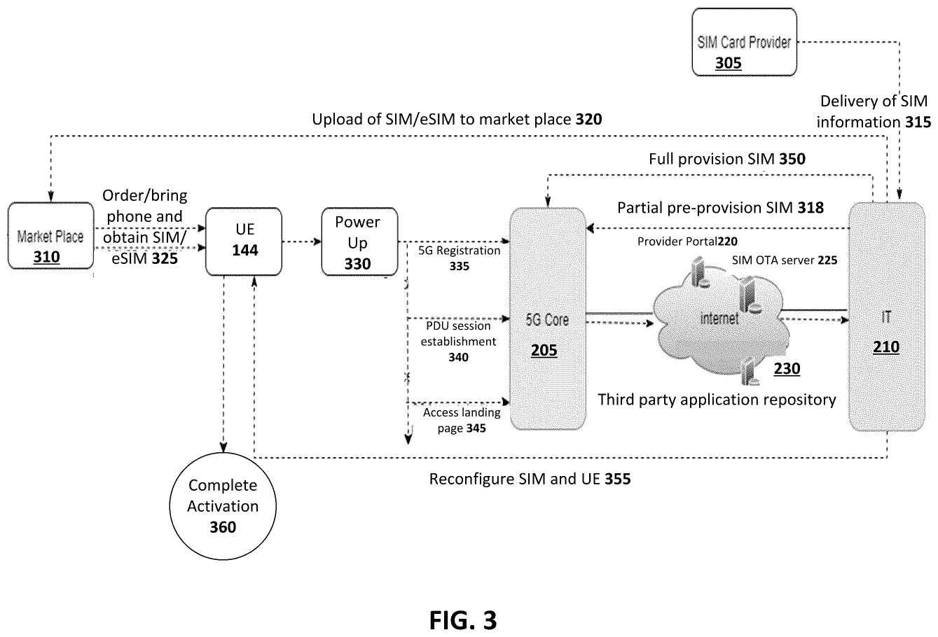

FIG. 3 is a schematic diagram illustrating a sequence of interactions to activate a new UE over a cellular network. In the example of FIG. 3, a SIM card provider 305 delivers (315) information about a SIM to the IT module 210, such as an API Gateway, of a cellular network. The SIM can be a physical SIM card that is insertable into an UE, or an embedded SIM (eSIM). Information about the SIM can include, for example, a subscription identification number that can be used to authenticate a UE to the cellular network, a phone number associated with the SIM, information about a data plan supported by the SIM, details about a corresponding wireless carrier, security information etc.

The IT module 210 can be configured to execute a partial pre-provisioning (318) of SIM/eSIM information received from the SIM card provider 305. This can include, for example, associating one or more network functions to the information corresponding to a particular SIM/eSIM such that the SIM/eSIM may eventually communicate over the cellular network prior to and for the purpose of being fully provisioned. For example, the IT module 210 can—configure a limited list of resources that the SIM/eSIM may access over the cellular network in order to be fully provisioned. Examples of such resources can include a landing page or portal 220 associated with the cellular service provider, a SIM OTA server 225, or a third party repository of applications 230. In some implementations, the partial pre-provisioning 318 can include associating a default APN/DNN for the UE to communicate over in the partially-provisioned state. The partially pre-provisioning information for the SIM/eSIM can then be provided to a network module of the 5G core. In some implementations, the pre-provisioning information can be stored in an UDM 112/UDR 114 of the 5G core 205. Other modules such as the AMF 102 or the SMF 104 can also be used to store/access the partial pre-provisioning information associated with different SIMs/eSIMs.

The SIM/eSIM information received by the IT module 210 from the SIM card provider 305 can be provided/uploaded to a marketplace 310. The marketplace 310 can include stores that sell physical SIM cards, as well as an electronic repository from which eSIM profiles may be downloaded. A user that buys a new UE (or brings his/her UE for a new connection) can also obtain (325) a SIM from the marketplace 310. This can include buying and inserting a physical SIM card into the UE 144 or downloading an eSIM profile onto the eSIM of the UE 144. The new connection is then ready to be activated.

When the UE is powered up with the new SIM/eSIM, the UE selects PLMN network based on the preconfigured information on the SIM/eSIM, and executes a registration process 335 with the 5G core 205. This can include, for example, authentication between the UE 144 and the core network 205 based on the credentials pre-provisioned in the 5G Core 205 through appropriate signaling, and setup of secure communication between the UE 144 and network at both RRC and NAS levels. A PDU session establishment process 340 is then initiated by the UE 144 and processed by the 5G core 205, which includes allocating the necessary resources for the data session, and assigning QoS and IP address. The PDU session is a logical connection between a UE and a specific data network. In some implementations, the PDU session is established with an IMS core network for IMS based services, e.g. Voice call and IP messaging. In some implementations, the PDU session is established for internet access. The data network is identified by an Access Point Name (APN) or Data Network Name (DNN), which is provisioned or pre-provisioned through IT 210 into 5G Core 205. In some implementations, if the request APN/DNN to establish the PDU session does not match the pre-provisioned APN/DNN, a network module of the 5G core 205 may override the request and use the pre-provisioned APN/DNN.

The UE 144 then accesses the Internet over the established PDU session to access the limited list of resources in order for the SIM/eSIM to be fully provisioned, and/or the UE to be configured. This can include retrieving, from the partially pre-provisioned SIM/eSIM, identification of one or more uniform resource locators (URLs) to access, and/or redirecting/hotlining the access URLs to be one of the limited list of applications, in order to complete provisioning of the SIM/eSIM and/or configuring the UE. For example, one of the URLs can direct a user to an account-setup page of the service provider associated with the cellular network. In some implementations, this can also include communicating over a Bearer Independent Protocol (BIP) channel with the SIM OTA server 225, and/or communicating with a third-party repository of applications (e.g., the App Store for iOS, Google Play Store for Android, etc.) to download one or more applications included in the limited list of resources.

Upon completion of the requisite tasks (account setup, phone number assignment or porting-in, etc.), a full provisioning (350) of the subscriber E is performed. This can include enabling, for example by the IT module 210, the UE to access all applicable services over the cellular network. Information about the full provisioning is then provided to the 5G core 205 for storing in an appropriate network module such as the UDM/UDR. In addition, configuration/reconfiguration information about the SIM/eSIM and/or the—device is provided (355) to the UE 144 such that the activation of the UE 144 is completed (360). This concludes the activation/on-boarding of the new SIM/eSIM and the UE is provided full access to all subscribed services over the cellular network.

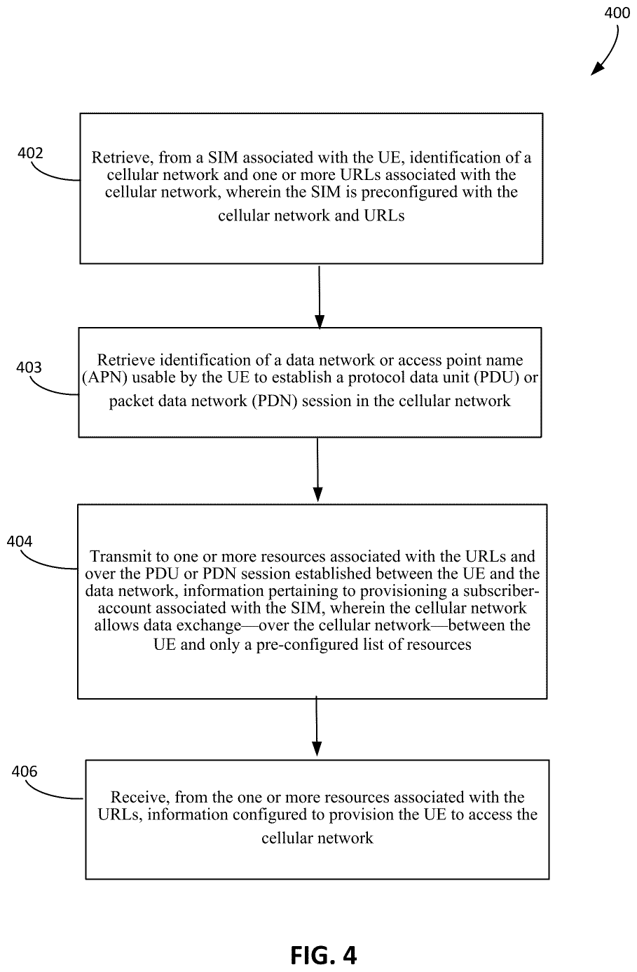

FIG. 4 is a flowchart of an example process 400 executed at a UE to get fully provisioned over a cellular network that can be home network or a roaming partner's cellular network. Operations of the process 400 includes retrieving, from a subscriber identification module (SIM) associated with the UE, different information, e.g., the mobile subscriber identity and credentials, identification of a cellular access network, such as a 5G Radio Access Network (RAN), and uniform resource locators (URLs), such as SIM over-the-air (OTA) Application Address (402). The SIM can be preconfigured with the information such as: mobile subscriber identity and associated credentials, identification of the cellular network (also referred to herein as cellular access network), and URLs of the SIM OTA Application Address, for example. In some implementations, the identification of the cellular access network can include one or more roaming partners so that the subscriber on-boarding or provisioning process can be achieved via the roaming partner's cellular access network when outside of the home cellular access network coverage. In some implementations, the identification of the URLs can include an URL to a SIM OTA Application for the cellular network described above with reference to FIG. 2.

Operations of the process 400 also includes retrieving, from the mobile device, the identification of a data network, e.g. a data network name (DNN), or an access point name (APN) usable by the UE to establish a Protocol Data Unit (PDU) or a Packet Data Network (PDN) session in the cellular network (403). In some implementations, the identification of a data network can include a DNN or an APN identifying a specific network operator's packet data network. The PDU or PDN session can be established, for example, by providing the mobile subscriber identity and associated credentials (i) to one or more network functions of the cellular network for an authentication and authorization process associated with the UE registration procedure to the cellular network, and/or (ii) to the DNN or APN for the PDU session or PDN connectivity establishment procedure.

Operations of the process 400 further includes transmitting to one or more resources associated with the URLs or applications over a Protocol Data Unit (PDU) session established between the UE and the data network via the cellular access network, information pertaining to provisioning the subscriber (404), e.g., a user-account associated with the subscriber. The cellular network allows data exchange-over the cellular network-between the UE and only a pre-configured list of resources. The data exchange over the PDU session with the pre-configured list of resources can be allowed even without the UE being fully provisioned to the cellular network. In some implementations, the resources in the preconfigured list can include a SIM OTA Application address configured to provide over-the-air (OTA) SIM configurations and management. In some implementations, the resources in the preconfigured list can include one or more application repositories (e.g., the third party repositories 230 described above with reference to FIG. 2) configured to store applications or software packages downloadable on the UE to provision the UE with a proper carrier service bundle or for firmware upgrades. In some implementations, the resources in the preconfigured list also include the customer portal the UE can access to for account setup and service subscription.

Operations of the process 400 also include receiving, from the one or more resources associated with the URLs, information configured to fully provision the UE to access the cellular network. Configuring the UE can include fully provisioning the SIM/eSIM of the UE to access all subscribed services over the cellular network.

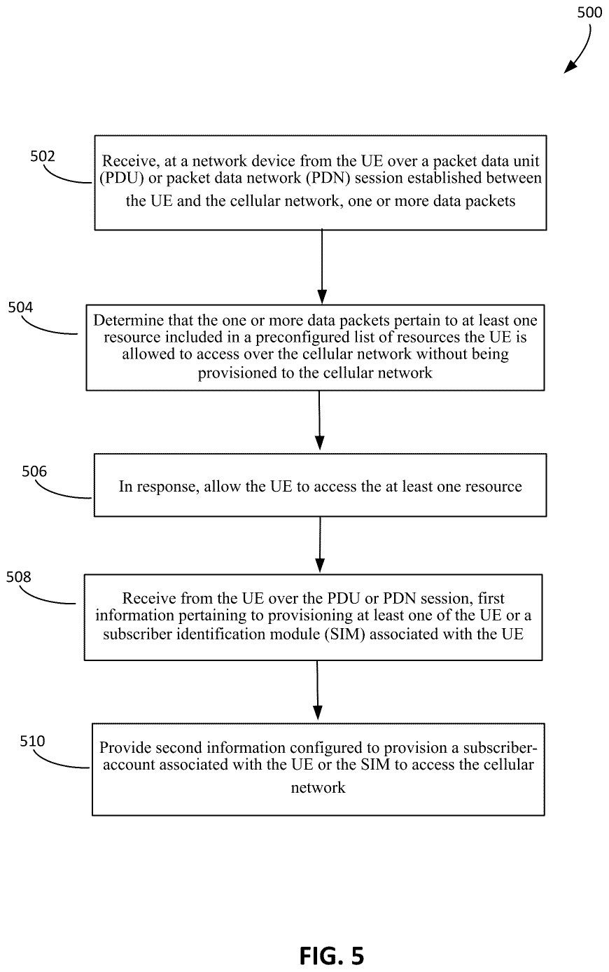

FIG. 5 is a flowchart of an example process 500 executed at one or more network devices to provision a UE over a cellular network. In some implementations, portions of the process 500 can be executed, for example, at one or more network function modules/devices of the 5G core 205 described above with respect to FIG. 2. For example, at least some portions of the process 500 can be executed at AMF 102, AUSF 110, and UDM 112/UDR 114, and other portions of the process can be executed at AMF 102, SMF 104/UPF 106, PCF 120, and CHF 121 as described above. The modules/devices providing the above network functions can be referred to herein as network devices. Execution of the process 500 can involve one or more of the other network modules of the 5G core described above with respect to FIG. 2.

Operations of the process 500 includes receiving, from the one or more resources associated with the URLs, information or software package to configure or provision the UE to access the cellular network, and transmitting the information or software package to the UE. The UE can then be configured based on the information or software package for provisioning the UE to access the cellular network. Configuring the UE can include full provisioning the SIM/eSIM of the UE and configuring the device with a proper carrier service bundle to access all subscribed services over the cellular network.

Operations of the process 500 includes receiving, at a network device from the UE over a Protocol Data Unit (PDU) or Packet Data Network (PDN) session established between the UE and the cellular network, one or more data packets (502). The PDU session can be established for data service over the cellular network without the UE being fully provisioned or the subscriber account being set up to access the cellular network. Operations of the process 500 can also include determining that the one or more data packets pertain to at least one resource included in a preconfigured list of resources the UE is allowed to access over the cellular network without being fully provisioned to the cellular network (504), and in response, allowing the UE to access the at least one resource (506).

Establishment of the PDU or PDN session can include receiving, from the UE, the registration and PDU/PDN session establishment requests to the cellular network, the subscriber mobile identity and its associated credentials, and APN/DNN along with a corresponding request. Establishment of the PDU session also includes authenticating/authorizing the UE for registration, and establishing the requested PDU session for data network access. In some implementations, if the APN/DNN in a PDU session establishment request from the UE does not match the APN/DNN preprovisioned in the cellular network, the network function can override the requested APN/DNN by using the preprovisioned APN/DNN to establish the PDU session.

In some implementations, the resources in the preconfigured list include a SIM OTA Application address configured to provide over-the-air (OTA) SIM configurations and management. For example, the server can be substantially identical to the SIM OTA server 225 described above with reference to FIGS. 2 and 3. In some implementations, the resources in the preconfigured list include one or more application repositories (e.g., the third party repositories 230 described above with reference to FIG. 2) configured to store applications and software packages downloadable on the UE to provision the UE with a proper carrier service bundle or for firmware upgrade, In some implementations, the resources in the preconfigured list also include the customer portal the UE can access to for account setup and service subscription.

In some implementations, operations of the process 500 includes determining that the one or more data packets destined for a website or an application that is not included in the preconfigured list of resources, and in response, redirecting the one or more data packets to the predefined website or application that is included in the preconfigured list of resources. For example, if the data packets are destined for a website, e.g. youtube.com, which is not allowed nor included in the preconfigured list of resources for the non-provisioned and unknown subscriber, the network functions (e.g. SMF 104 and/or UPF 106) can be configured to route the one or more data packets to a predefined website address, such as customer portal, that is preconfigured in the allowed resource list, so the subscriber can setup the account online.

Operations of the process 500 also includes receiving, for example at an Information Technology (IT) network device or module, from the UE over the PDU session, first information pertaining to provisioning a subscriber associated with the UE or SIM (508). The first information can include, for example, information pertaining to the subscriber account setup, e.g. name, address, device model, service subscription, billing information and charging method, establishing the subscriber account based on the received information, assigning a phone number if not yet available or executing the number porting-in process, initiating the full network provisioning procedure according to the subscriber's subscription, and triggering the SIM OTA provisioning and device configurations.

Operations of the process 500 also includes providing, second information configured to provision a subscriber-account associated with the UE or the SIM to access the cellular network (510). In some implementations, the second information can be provided to an Application module, e.g. a number portability platform, or to a cellular network function, such as UDR 114 or CHF 121, or to the UE over the PDU session. In some implementations, the second information is sent in response to the successful result of processing the first information associated with provisioning the subscriber or the UE. In some implementations, the first information and the second information can be independent of each other. For example, the IT network device or module can simultaneously send the first specific information to the cellular network function UDR 114 and the second relevant information to the cellular network function CHF 121, so the information associated with provisioning the UE can be processed and stored independently in each corresponding network function.

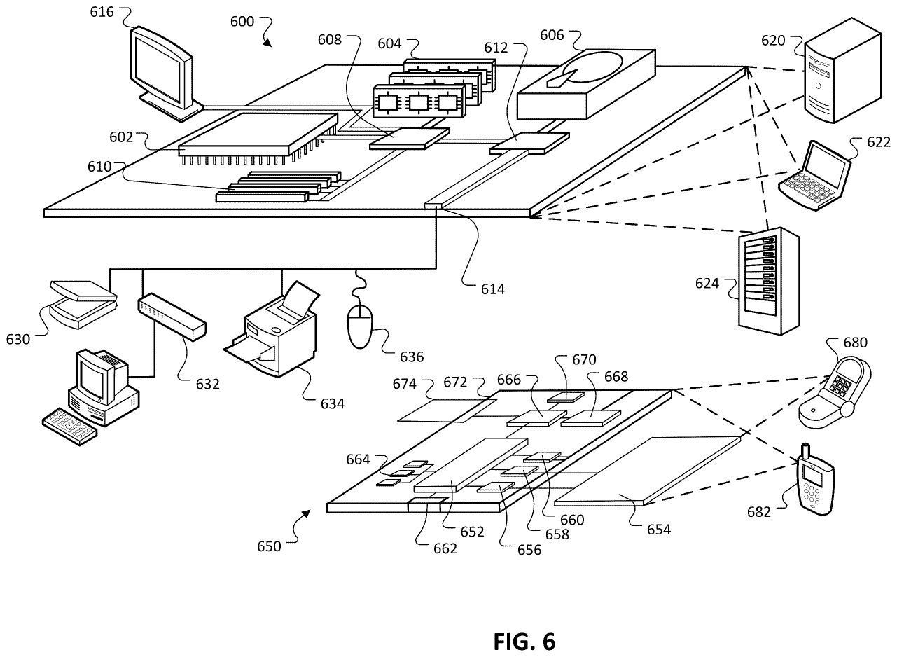

FIG. 6 shows an example of a computing device 600 and a mobile computing device 650 that are employed to execute implementations of the present disclosure. The computing device 600 is intended to represent various forms of digital computers, such as laptops, desktops, workstations, personal digital assistants, servers, blade servers, mainframes, and other appropriate computers. The mobile computing device 650 is intended to represent various forms of mobile devices, such as personal digital assistants, cellular telephones, smart-phones, AR devices, and other similar computing devices. The components shown here, their connections and relationships, and their functions, are meant to be examples only, and are not meant to be limiting. The computing device 600 and/or the mobile computing device 650 can form at least a portion of the network environments (e.g., environment 100) described above. The computing device 600 and/or the mobile computing device 650 can also form at least a portion of the UE 144 described above. In some implementations, the network functions and/or network entities described above can be implemented using a cloud infrastructure including multiple computing devices 600 and/or mobile computing devices 650.

The computing device 600 includes a processor 602, a memory 604, a storage device 606, a high-speed interface 608, and a low-speed interface 612. In some implementations, the high-speed interface 608 connects to the memory 604 and multiple high-speed expansion ports 610. In some implementations, the low-speed interface 612 connects to a low-speed expansion port 614 and the storage device 606. Each of the processor 602, the memory 604, the storage device 606, the high-speed interface 608, the high-speed expansion ports 610, and the low-speed interface 612, are interconnected using various buses, and may be mounted on a common motherboard or in other manners as appropriate. The processor 602 can process instructions for execution within the computing device 600, including instructions stored in the memory 604 and/or on the storage device 606 to display graphical information for a graphical user interface (GUI) on an external input/output device, such as a display 616 coupled to the high-speed interface 608. In other implementations, multiple processors and/or multiple buses may be used, as appropriate, along with multiple memories and types of memory. In addition, multiple computing devices may be connected, with each device providing portions of the necessary operations (e.g., as a server bank, a group of blade servers, or a multi-processor system).

The memory 604 stores information within the computing device 600. In some implementations, the memory 604 is a volatile memory unit or units. In some implementations, the memory 604 is a non-volatile memory unit or units. The memory 604 may also be another form of a computer-readable medium, such as a magnetic or optical disk.

The storage device 606 is capable of providing mass storage for the computing device 600. In some implementations, the storage device 606 may be or include a computer-readable medium, such as a floppy disk device, a hard disk device, an optical disk device, a tape device, a flash memory, or other similar solid-state memory device, or an array of devices, including devices in a storage area network or other configurations. Instructions can be stored in an information carrier. The instructions, when executed by one or more processing devices, such as processor 602, perform one or more methods, such as those described above. The instructions can also be stored by one or more storage devices, such as computer-readable or machine-readable mediums, such as the memory 604, the storage device 606, or memory on the processor 602.

The high-speed interface 608 manages bandwidth-intensive operations for the computing device 600, while the low-speed interface 612 manages lower bandwidth-intensive operations. Such allocation of functions is an example only. In some implementations, the high-speed interface 608 is coupled to the memory 604, the display 616 (e.g., through a graphics processor or accelerator), and to the high-speed expansion ports 610, which may accept various expansion cards. In the implementation, the low-speed interface 612 is coupled to the storage device 606 and the low-speed expansion port 614. The low-speed expansion port 614, which may include various communication ports (e.g., Universal Serial Bus (USB), Bluetooth, Ethernet, wireless Ethernet) may be coupled to one or more input/output devices. Such input/output devices may include a scanner, a printing device, or a keyboard or mouse. The input/output devices may also be coupled to the low-speed expansion port 614 through a network adapter. Such network input/output devices may include, for example, a switch or router.

The computing device 600 may be implemented in a number of different forms, as shown in the FIG. 6. For example, it may be implemented as a standard server 620, or multiple times in a group of such servers. In addition, it may be implemented in a personal computer such as a laptop computer 622. It may also be implemented as part of a rack server system 624. Alternatively, components from the computing device 600 may be combined with other components in a mobile device, such as a mobile computing device 650. Each of such devices may contain one or more of the computing device 600 and the mobile computing device 650, and an entire system may be made up of multiple computing devices communicating with each other.

The mobile computing device 650 includes a processor 652; a memory 664; an input/output device, such as a display 654; a communication interface 666; and a transceiver 668; among other components. The mobile computing device 650 may also be provided with a storage device, such as a micro-drive or other device, to provide additional storage. Each of the processor 652, the memory 664, the display 654, the communication interface 666, and the transceiver 668, are interconnected using various buses, and several of the components may be mounted on a common motherboard or in other manners as appropriate. In some implementations, the mobile computing device 650 may include a camera device(s).

The processor 652 can execute instructions within the mobile computing device 650, including instructions stored in the memory 664. The processor 652 may be implemented as a chipset of chips that include separate and multiple analog and digital processors. For example, the processor 652 may be a Complex Instruction Set Computers (CISC) processor, a Reduced Instruction Set Computer (RISC) processor, or a Minimal Instruction Set Computer (MISC) processor. The processor 652 may provide, for example, for coordination of the other components of the mobile computing device 650, such as control of user interfaces (UIs), applications run by the mobile computing device 650, and/or wireless communication by the mobile computing device 650.

The processor 652 may communicate with a user through a control interface 658 and a display interface 656 coupled to the display 654. The display 654 may be, for example, a Thin-Film-Transistor Liquid Crystal Display (TFT) display, an Organic Light Emitting Diode (OLED) display, or other appropriate display technology. The display interface 656 may include appropriate circuitry for driving the display 654 to present graphical and other information to a user. The control interface 658 may receive commands from a user and convert them for submission to the processor 652. In addition, an external interface 662 may provide communication with the processor 652, so as to enable near area communication of the mobile computing device 650 with other devices. The external interface 662 may provide, for example, for wired communication in some implementations, or for wireless communication in other implementations, and multiple interfaces may also be used.

The memory 664 stores information within the mobile computing device 650. The memory 664 can be implemented as one or more of a computer-readable medium or media, a volatile memory unit or units, or a non-volatile memory unit or units. An expansion memory 674 may also be provided and connected to the mobile computing device 650 through an expansion interface 672, which may include, for example, a Single in Line Memory Module (SIMM) card interface. The expansion memory 674 may provide extra storage space for the mobile computing device 650, or may also store applications or other information for the mobile computing device 650. Specifically, the expansion memory 674 may include instructions to carry out or supplement the processes described above, and may include secure information also. Thus, for example, the expansion memory 674 may be provided as a security module for the mobile computing device 650, and may be programmed with instructions that permit secure use of the mobile computing device 650. In addition, secure applications may be provided via the SIMM cards, along with additional information, such as placing identifying information on the SIMM card in a non-hackable manner.

The memory may include, for example, flash memory and/or non-volatile random access memory (NVRAM), as discussed below. In some implementations, instructions are stored in an information carrier. The instructions, when executed by one or more processing devices, such as processor 652, perform one or more methods, such as those described above. The instructions can also be stored by one or more storage devices, such as one or more computer-readable or machine-readable mediums, such as the memory 664, the expansion memory 674, or memory on the processor 652. In some implementations, the instructions can be received in a propagated signal, such as, over the transceiver 668 or the external interface 662.

The mobile computing device 650 may communicate wirelessly through the communication interface 666, which may include digital signal processing circuitry where necessary. The communication interface 666 may provide for communications under various modes or protocols, such as Global System for Mobile communications (GSM) voice calls, Short Message Service (SMS), Enhanced Messaging Service (EMS), Multimedia Messaging Service (MMS) messaging, code division multiple access (CDMA), time division multiple access (TDMA), Personal Digital Cellular (PDC), Wideband Code Division Multiple Access (WCDMA), CDMA2000, General Packet Radio Service (GPRS), IP Multimedia Subsystem (IMS) technologies, and 6G technologies. Such communication may occur, for example, through the transceiver 668 using a radio frequency. In addition, short-range communication, such as using a Bluetooth or Wi-Fi, may occur. In addition, a Global Positioning System (GPS) receiver module 670 may provide additional navigation- and location-related wireless data to the mobile computing device 650, which may be used as appropriate by applications running on the mobile computing device 650.

The mobile computing device 650 may also communicate audibly using an audio codec 660, which may receive spoken information from a user and convert it to usable digital information. The audio codec 660 may likewise generate audible sound for a user, such as through a speaker, e.g., in a handset of the mobile computing device 650. Such sound may include sound from voice telephone calls, may include recorded sound (e.g., voice messages, music files, etc.) and may also include sound generated by applications operating on the mobile computing device 650.

The mobile computing device 650 may be implemented in a number of different forms, as shown in FIG. 6. For example, it may be implemented in the UE described with respect to FIG. 1. Other implementations may include a phone device 680, a personal digital assistant 682, and a tablet device (not shown). The mobile computing device 650 may also be implemented as a component of a smart-phone, AR device, or other similar mobile device.

The computing device 600 may be implemented in the network environment 100 described above with respect to FIGS. 1-3.

Computing device 600 and/or 650 can also include USB flash drives. The USB flash drives may store operating systems and other applications. The USB flash drives can include input/output components, such as a wireless transmitter or USB connector that may be inserted into a USB port of another computing device.

Other embodiments and applications not specifically described herein are also within the scope of the following claims. Elements of different implementations described herein may be combined to form other embodiments.

What is claimed is:

1. A method of provisioning a user equipment (UE) over a cellular network, the method comprising:
receiving, at a network device from the UE over a protocol data unit (PDU) session or a packet data network (PDN) session established between the UE and the cellular network, one or more data packets;
determining that the one or more data packets pertain to at least one resource included in a preconfigured list of resources the UE is allowed to access over the cellular network without being provisioned to the cellular network;
responsive to determining that the at least one resource is included in the preconfigured list of resources, allowing the UE to access the at least one resource;
receiving, from the UE over the PDU session, first information pertaining to provisioning at least one of the UE or a subscriber identification module (SIM) associated with the UE; and
providing second information configured to provision a subscriber-account associated with the UE or the SIM, to access the cellular network.

2. The method of claim 1, wherein the network device is configured to implement a module of a 5G core.

3. The method of claim 2, wherein the module of the 5G core is one of: an access management function (AMF) module or a user plane function (UPF) module.

4. The method of claim 1, further comprising:
receiving and storing the preconfigured list of resources at the network device.

5. The method of claim 1, wherein the resources in the preconfigured list comprise a SIM over-the-air (OTA) application.

6. The method of claim 1, wherein the resources in the preconfigured list comprise one or more application repositories configured to store applications downloadable on the UE to provision the UE to access the cellular network, and the applications downloadable on the UE to provision the UE to access the cellular network.

7. The method of claim 1, wherein the PDU session is established for data service over the cellular network without the UE being provisioned to access the cellular network.

8. The method of claim 1, further comprising:
determining that the one or more data packets include an identification of a first data network that is not included in the preconfigured list of resources; and
in response to determining that the one or more data packets include the identification of the first data network, routing the one or more data packets over a second data network that is included in the preconfigured list of resources.

9. The method of claim 1, wherein the preconfigured list of resources includes at least one of an access point name (APN) or a data network name (DNN) associated with the cellular network.

10. A device comprising:
memory configured to store computer-readable instructions; and
one or more computing devices operatively coupled to the memory, configured to execute the computer-readable instructions to perform operations comprising:
receiving from a user equipment (UE) over a protocol data unit (PDU) session or a packet data network (PDN) session established between the UE and a cellular network, one or more data packets,
determining that the one or more data packets pertain to at least one resource included in a preconfigured list of resources the UE is allowed to access over the cellular network without being provisioned to the cellular network,
responsive to determining that the at least one resource is included in the preconfigured list of resources, allowing the UE to access the at least one resource,
receiving, from the UE over the PDU session, first information pertaining to provisioning at least one of the UE or a subscriber identification module (SIM) associated with the UE, and
providing second information configured to provision a subscriber-account associated with the UE or the SIM to access the cellular network.

11. The device of claim 10, wherein the device is configured to implement a module of a 5G core.

12. The device of claim 11, wherein the module of the 5G core is one of: an access management function (AMF) module or a user plane function (UPF) module.

13. The device of claim 10, the operations further comprising:
receiving and storing the preconfigured list of resources at the device.

14. The device of claim 10, wherein the resources in the preconfigured list comprise a SIM over-the-air (OTA) application.

15. The device of claim 10, wherein the resources in the preconfigured list comprise one or more application repositories configured to store applications downloadable on the UE to provision the UE to access the cellular network, and the applications downloadable on the UE to provision the UE to access the cellular network.

16. The device of claim 10, wherein the PDU session is established for data service over the cellular network without the UE being provisioned to access the cellular network.

17. The device of claim 10, the operations further comprising:
determining that the one or more data packets include an identification of a first data network that is not included in the preconfigured list of resources; and
in response to determining that the one or more data packets include the identification of the first data network, routing the one or more data packets over a second data network that is included in the preconfigured list of resources.

18. The device of claim 10, wherein the preconfigured list of resources includes at least one of an access point name (APN) or a data network name (DNN) associated with the cellular network.

19. One or more non-transitory computer-readable storage devices configured to store computer-readable instructions, which, upon execution by one or more computing devices cause the one or more computing devices to perform operations comprising:
receiving from a user equipment (UE) over a protocol data unit (PDU) session or a packet data network (PDN) session established between the UE and a cellular network, one or more data packets,
determining that the one or more data packets pertain to at least one resource included in a preconfigured list of resources the UE is allowed to access over the cellular network without being provisioned to the cellular network,
responsive to determining that the at least one resource is included in the preconfigured list of resources, allowing the UE to access the at least one resource,
receiving, from the UE over the PDU session, first information pertaining to provisioning at least one of the UE or a subscriber identification module (SIM) associated with the UE, and
providing second information configured to provision a subscriber-account associated with the UE or the SIM to access the cellular network.

20. The one or more non-transitory computer-readable storage devices of claim 19, wherein the PDU session or the PDN session is established for data service over the cellular network without the UE being fully provisioned to access the cellular network.
